(19) United States
(12) Patent Application Publication
(10) Pub. No.: US 2017/0193375 A1
(43) Pub. Date: Jul. 6, 2017

(54) RULE GUIDED FABRICATION OF STRUCTURED DATA AND MESSAGES

(71) Applicant: International Business Machines Corporation, Armonk, NY (US)

(72) Inventors: Akram Bitar, Kfar Peqiin (IL); Oleg Blinder, Haifa (IL); Ronen Levy, Haifa (IL); Tamer Salman, Haifa (IL)

(21) Appl. No.: 14/983,807

(22) Filed: Dec. 30, 2015

(51) Int. Cl. G06N 5/04

(52) U.S. Cl. CPC G06N 5/046

(57) ABSTRACT

Embodiments are directed to a computer implemented method for fabricating test data. The method includes receiving, using a processor system, a file format layout having variables. The method further includes receiving, using the processor system, rules that are defined independently of the file format layout, wherein the rules impose constraints on the variables. The method further includes defining a constraint problem based on the variables and the constraints, and solving the constraint problem.

### BACKGROUND

The present disclosure relates in general to the field of data fabrication. More specifically, the present disclosure relates to the rule guided fabrication of a variety of structured data types including, messages, flat files, data streams, web service calls, and the like.

Computerized devices and systems are involved in almost every aspect of modern life. Many computerized systems gather or use significant amounts of data about products, processes, individuals, and other entities. The data may be arranged in a variety of structured formats, including for example databases, messages, flat files, data streams, web service calls, and the like. The structured data is typically organized in a manner that models relevant aspects of reality, as well as in a manner that supports the various processes that may require the structured data.

Structured data is usually accessed indirectly through one or more applications acting as intermediaries that issue queries to the structured data. For example, instead of directly reading or updating a specific field within a data structure or a table, the balance of a bank account is usually updated or accessed electronically by a dedicated application provided to an agent, or provided to the customer using a web service after proper identification. It is a challenge to obtain high-quality data for testing an application according to test requirements. Although data for testing an application may be manually fabricated, such operation may require significant manual labor. Furthermore, manually fabricated data may be non-realistic, inconsistent, or meaningless, or at least may have distributions that are different than those of real life data based on real scenarios and populations.

It is known to provide computer systems and methodologies for fabricating data into databases, and specifically for fabricating data into relational databases (i.e., databases structured to recognize relationships among stored items of information) based on defined variables, rules that are imposed on the defined variables, and constraints on the rules. However, the particular layout of the file format chosen for the structured data imposes limits on the rule complexity and variable relationships that may be represented in the chosen file format layout using known systems. For example, because a relational database is organized into tables and columns, if a variable X is created in the database, a rule may be defined that constrains X as, for example, a random number. Similarly, if a variable Y is created in the database, a rule may be defined that constrains Y as, for example, a sequential number. However, once X and Y are individually constrained, a rule could not then be defined that constrains both X and Y within the same rule. Accordingly, know systems limit the complexity of the rules and variable relationships around which structured data can be fabricated.

It would be beneficial to provide systems and methodologies for fabricating data into different types of data structures based on complex variable relationships, complex rules that are imposed on the variables, and complex constraints on the rules.

### SUMMARY

Embodiments are directed to a computer implemented method for fabricating test data. The method includes receiving, using a processor system, a file format layout having variables. The method further includes receiving, using the processor system, rules that are defined independently of the file format layout, wherein the rules impose constraints on the variables. The method further includes defining a constraint problem based on the variables and the constraints, and solving the constraint problem.

Embodiments are further directed to a computer system for fabricating test data. The computer system includes a memory and a processor system communicatively coupled to the memory. The processor system is configured to perform a method that includes receiving a file format layout having variables, and receiving rules that are defined independently of the file format layout, wherein the rules impose constraints on the variables. The method further includes defining a constraint problem based on the variables and the constraints, and solving the constraint problem.

Embodiments are further directed to a computer program product for fabricating test data. The computer program product includes a computer readable storage medium having program instructions embodied therewith, wherein the computer readable storage medium is not a transitory signal per se. The program instructions are readable by a processor system to cause the processor system to perform a method. The method includes receiving a file format layout having variables, and receiving rules that are defined independently of the file format layout, wherein the rules impose constraints on the variables. The method further includes defining a constraint problem based on the variables and the constraints, and solving the constraint problem.

Additional features and advantages are realized through techniques described herein. Other embodiments and aspects are described in detail herein. For a better understanding, refer to the description and to the drawings.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary system and methodology according to one or more embodiments of the present disclosure;

FIG. 2A depicts an example implementation of a portion of the system and methodology shown in FIG. 1;

FIG. 2B depicts an example implementation of another portion of the system and methodology shown in FIG. 1;

FIG. 2C depicts an example implementation of another portion of the system and methodology shown in FIG. 1;

FIG. 3 depicts an exemplary computer system capable of implementing one or more embodiments of the present disclosure; and

FIG. 4 depicts a computer program product according to one or more embodiments.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

Additionally, it is understood in advance that although this disclosure includes a detailed description of processing variables and rules to generate fabricated data, implementation of the teachings recited herein are not limited to particular data fabrication configurations. Rather, embodiments of the present disclosure are capable of being implemented in conjunction with any other type of data fabrication configuration and/or computing environment now known or later developed.

Turning now to an overview of the present disclosure, the disclosed rule guided fabrication of structured data and messages allows fabricating test data according to rules. The rules describe requirements that the fabricated data is required to satisfy, mainly in order to simulate real data. These rules may be defined by a testing engineer (i.e., a user) and/or may be automatically obtained from the involved environments. The disclosed data fabrication further allows fabrication of test data based on a combination of various rule types (such as analytics, constraints, knowledge base, programmatic, transformation etc.), which are based on business logic and testing logic on top of data logic. The disclosed data fabrication may be a constraint satisfaction problem (CSP) based data fabrication solution.

According to the present disclosure, rules are defined independently of the ultimate file format layout that will be chosen for the test data. Because rules are defined independently of the file format layout, the complexity of the rules is not limited by the file format layout. Also because the rules are defined independently of the file format layout, complex relationships may be established between defined variables, complex rules may be imposed on the defined variables, and complex constraints may be derived from the complex rules. Also because the rules are defined independently of file format layout, the file format layout may take a variety of forms, including for example databases, messages, flat files, data streams, web service calls, and the like. Flat files can include positional, hierarchical, TSV, CSV, XML, XSD, JSON and other formats.

Such rules may allow fabrication of test data that represent real world data by having similar characteristics as real world data. For example, certain attributes of the generated data may have the same distribution as the real world data. As another example, the values of certain attributes of the generated data may comply with some constraints. Furthermore, such rules may allow corner case testing.

The data fabrication process according to the present disclosure may be hierarchical to allow an ordered, efficient and easy to define fabrication process. Accordingly, hierarchical requirements and hierarchical rules may be utilized.

The disclosed data fabrication may support the generation of new data, transformation of existing data or a combination thereof. For example, when testing a shop application, data relating to existing purchases and orders for some products may be used. However, private data relating to the clients who made these orders, such as names, addresses, and credit card information may not be used. Thus, according to the disclosed data fabrication, one may fabricate clients and their information, but may still use the details of the orders and purchases.

The disclosed data fabrication may be used for generating data which may be utilized for developing and testing applications (e.g., large scale enterprise data-intensive or data-driven applications) for which not enough data is available or accessible. Because no real data may be used in the generation of the test data, no privacy or other regulations related to the real data may be infringed.

Hence, the disclosed data fabrication may allow intensive generation of high-quality and diverse test data (i.e., according to various requirements), or the transformation of existing data, without violating privacy policies and in an automatic and relatively simple manner.

The term “rules” as referred to herein, may relate to data fabrication rules and/or meta-rules.

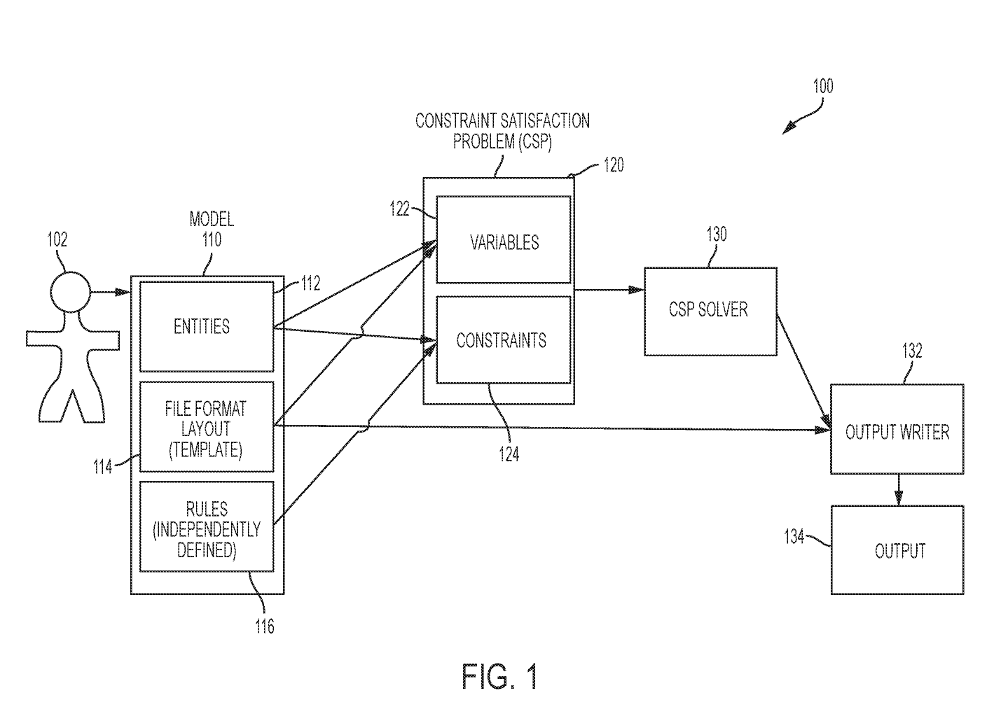

Turning now to a detailed description of the present disclosure, FIG. 1 depicts a diagram illustrating a data fabrication system 100 and associated methodology according to one or more embodiments. System 100 includes a model 110 created by a user 102, a CSP 120, a CSP solver 130, an output writer 132 and an output 134, configured and arranged as shown. Constraint problem 120 includes variables 122 and constraints 124. Model 110 includes entities 112, a file format layout (or template) 114 and rules 116. According to the present disclosure, rules 116 are defined independently of file format layout 114, which means that the complexity of rules 116 is not limited by file format layout 114. Allowing rules 116 to be defined independently allows complex relationships between variables 122, complex rules 116 imposed on variables 122, and complex constraints 124 on rules 116. Allowing rules 116 to be defined independently further allows file format layout 114 to take a variety of forms, including for example databases, messages, flat files, data streams, web service calls, and the like. Flat files can include positional, hierarchical, TSV, CSV, XML, XSD, JSON and other formats.

In operation, under system 100, user 102 creates model 110, which models a data fabrication problem in three parts, namely entities 112, file format layout 114 and rules 116. User 102 may develop model 110 based on a variety of data sources. The data sources may include various types of data, such as real world data, manually generated data, or the like. The data is assumed to have at least some relevance to data to be used by one or more applications, for example in order to test the applications. The data sources may include one or more knowledge-bases to be used with knowledge-base rules, as will be described below. A knowledge-base may include data to be used as test data for an application. For example, when testing a shop application, knowledge bases such as a knowledge base of U.S. addresses (e.g., streets, cities, states and zip codes), a knowledge base of last names, and a knowledge base of first names associated with gender may be used to fabricate client information. Model 110 can be given in an XML, XSD, or other textual, binary, or graphical representation.

File format layout 114 describes the structure of the data, which can be a file format layout (or template) of a flat file (e.g., positional, hierarchical, TSV, CSV, XML, XSD, JSON and others), or a structure of a stream of messages (e.g., web-services calls, TCP packets, IBM MQ series and others).

Entities 112 include defining the different variables/entities that are used in file format layout 114. In textual files, the variables are of different types, such as int/float/string/date/etc. In binary files, the variables can be described with the number of bytes each variable holds. Other directives, such as the operating system properties, can be given as well. These directives can also be used when output 134 is generated.

Rules 116 are used to derive constraints 124, which are imposed between variables 122, which are derived from entities 112. According to the present disclosure, rules 116 are defined independently of file format layout 114. In other words the complexity of rules 116 is not in any way limited by the structure of file format 114. Rules 116, referred to below as data fabrication rules, may include one or more types, such as constraint rules, transformation rules, knowledge-based rules, programmatic rules, analytics rules and generic rules. In some embodiments the plurality of data fabrication rules may include data fabrication rules of two or more types.

Constraint rules may describe constraints on any type of property. Constraint rules, according to the present disclosure are not limited by characteristics of file format layout 114, such as attributes of tables, a relation between two attributes or a domain of values for an attribute.

Transformation rules may describe a transformation that should be performed on one or more attributes of data from a data source. Such rules may transform values from a source attribute into another attribute of a different type or of the same type. For example, a transformation rule may define how to transform the data, such as moving a date attribute to one year ahead.

Knowledge base rules may describe a resource of knowledge for one or more attributes. In such rules, the fabricated data may be selected from a set of possible values in the knowledge base. For example, a knowledge-base rule may define how to select values for certain attributes, such as first names and gender to be selected from a U.S. repository (i.e., a knowledge-base).

Programmatic rules may be embodied as pieces of code written in an operative language, such that when executed, result in a value for one or more attributes. Programmatic rules may receive inputs and produce outputs to be associated with attributes. In some embodiments, users may define programmatic rules to be used in the fabrication of data. For example, a programmatic rule may be a piece of code which may generate values according to some logic, such as a credit card info generator, which may produce random fake but valid credit card numbers and issuer names.

Analytics rules may provide some information concerning one or more attributes. According to some embodiments, analytics may be performed in a further step, as known in the art. Analytics may be performed with respect to data in order to extract a set of one or more properties which may characterize the data, such as distribution of one or more attributes, interdependency between attributes, or the like. At least some of the analytics rules may then be based on the analytics results. For example, an analytics rule may define how a set of attributes is distributed, such as the age and gender of clients

According to some embodiments, analytics may be performed by external (third party) analytics tools and at least some of the analytics rules may be based on such analytics results. Such analytics tools may be any appropriate tool, such as IBM InfoSphere Discovery engine, or IBM Information Analyzer, both provided by International Business Machines of Armonk, N.Y., United States.

A generic rule is a rule that may combine two or more types of rules. For example, a combination of a knowledge-based rule and a constraint rule may define how to fabricate a name which includes a family name and an initial (e.g., Salman T.) from a knowledge-base of family names and a knowledge-base of first names. As an example, a combination of a programmatic rule and a constraint rule may define how to fabricate an invalid credit card number. A programmatic rule may be used to generate a valid credit card number and a constraint rule may be used to change the number to invalid one.

The data fabrication rules may be hierarchically structured. The rules may be organized and grouped in a hierarchical structure for ease of navigation and use. Rules defined in deeper levels of the hierarchy may be refinements to rules on higher levels.

In some embodiments, the obtaining of the data fabrication rules may include receiving at least a portion of the rules. For example, the rules (or a portion of them) may be defined by user 102. User 102 may further define a rule hierarchy. In some embodiments, the obtaining of the data fabrication rules may include automatically acquiring at least a portion of the plurality of rules from the involved environments, such as rules based on the referential integrity (primary or foreign keys) which constraint the possible values for the relevant attributes.

The data fabrication rules may be received, formed or clustered as sets of rules according to their use and/or context. For example, rules which refer to the defining of client records may be clustered to a set of rules which may be classified as client creation rules. The clustering of the rules may allow an easier use, share and/or import/export of the rules.

The entity definitions formulated under entity 112 and file format layout 114 are then used to generate a set of variables at variables 122. For example, for a variable name that should appear in 100 lines in the flat file, can be defined by an array name. The entity definitions formulated under entity 112 and rules 116 are then used to generate a set of constraints at constraints 124.

With variables 122 and constraints 124 sufficiently defined, system 100 builds CSP 120 using variables 122 and constraints 124. CSPs are mathematical problems defined as a set of objects whose state must satisfy a number of constraints or limitations. CSPs represent the entities in a problem as a homogeneous collection of finite constraints over variables. CSP 120 is solved using CSP solver 130. The output of CSP solver 130 is an assignment of fabricated data to each one of the variables (i.e., variables 122). Alternatively, the fabricated test data may be generated using any known required method or solving tool, such as but not limited to a satisfiability (SAT) solver, a satisfiability modulo theories (SMT) solver, or any other solver.

Optionally, additional processing actions (e.g., additional analytics or the use of programmatic rules to obtain values) may be applied upstream from CSP solver 130, and additional processing actions (e.g., other types of programmatic rules that use fabricated values) may be applied downstream from CSP solver 130.

Output writer 132 receives the output from CSP 130 and file format layout 114 and applies to the file format layout the fabricated data that has been assigned to each one of the variables. Accordingly, output 134 is a set of fabricated data that is organized under file format layout 114 (e.g., a flat file, stream, etc.), and that follows rules 116. According to the present disclosure, because rules 116 were defined independently of file format layout 114, the complexity of rules 116 is not limited by file format layout 114. Also because rules 116 were defined independently of file format layout 114, complex relationships may be established between variables 122, complex rules 116 may be imposed on variables 122, and complex constraints 124 may be derived from rules 116. Also because rules 116 were defined independently of file format layout 114, file format layout 114 may take a variety of forms, including for example databases, messages, flat files, data streams, web service calls, and the like. Flat files can include positional, hierarchical, TSV, CSV, XML, XSD, JSON and other formats.

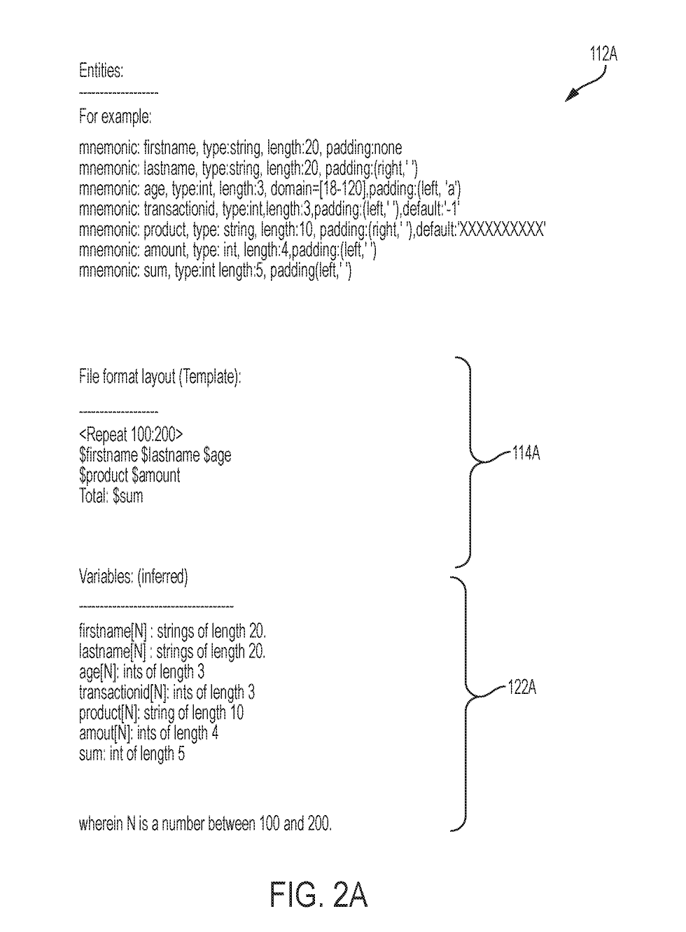

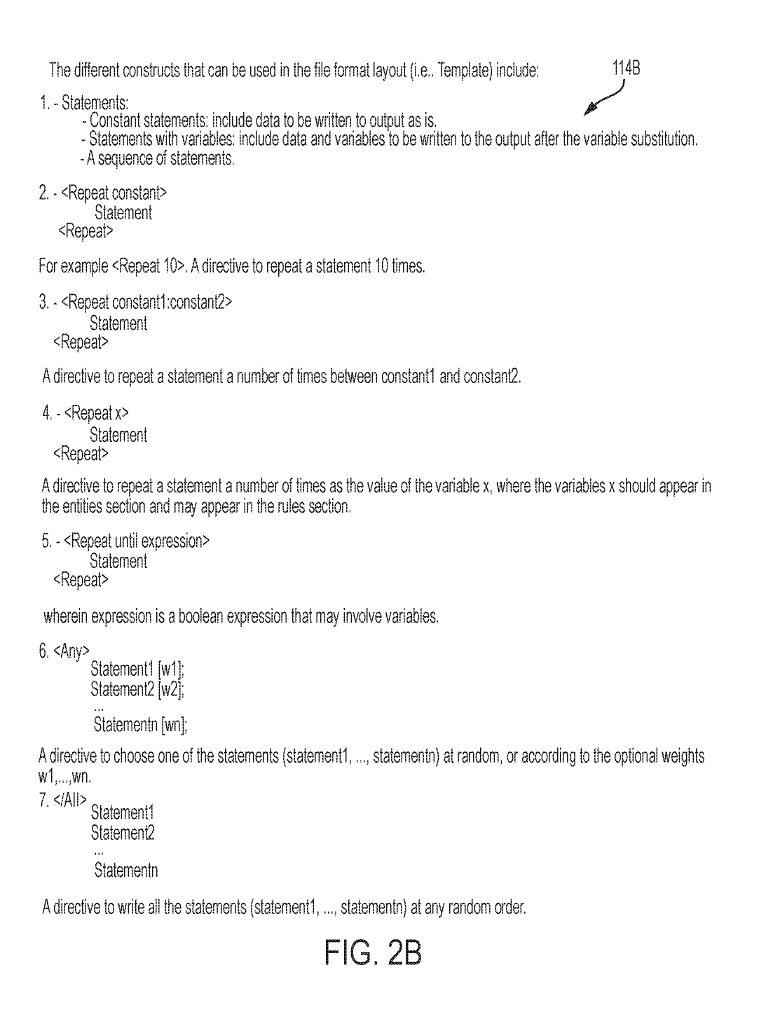

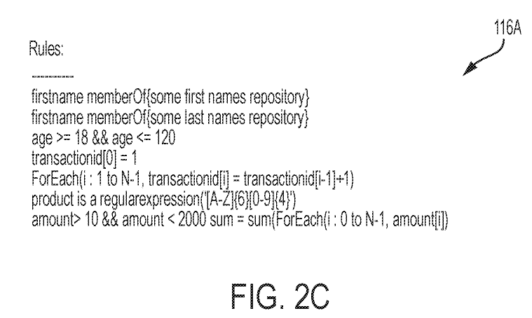

FIGS. 2A, 2B and 2C depict examples of how model 110, entities 112, file format layout 114 and rules 116 can be developed. In the following description of the examples illustrated in FIGS. 2A, 2B and 2C, references made to attributes of the illustrated examples apply specifically to the illustrated examples, as well as to embodiments of the present disclosure in general.

As shown in FIG. 2A, entities 112A contains a set of variables, wherein each variable has a mnemonic, type, length, domain, padding info (e.g., left/right & character), and possibly a default value. A variable can also be a hierarchical structure of variables. Furthermore, entities 112A can include auxiliary variables. Auxiliary variables are defined in entities 112A and can be used in rules 116A (e.g., involved in constraints that relate other variables). However, auxiliary variables do not generally appear in file format layout 114A and their values are not intended to be written to output 134.

File format layout 114A describes the template of the flat file with a declarative language that includes repetitions hierarchy, and that includes using the entities defined in entities 112A. File format 114A specifies that the flat files to be generated should include between 100 and 200 records, and specifies that each record includes a first name and last name followed by an age, a product name and an amount. At the end of the flat file is a line with the string “Total:” followed by the number sum.

Once entities 112A and file format layout 114A are given, a list of variables 122A can be inferred. An entity that appears inside a <repeat> yields an array of elements, wherein each element is of the same type as the entity. The different constructs that can be used in the file format layout definition 114A are shown at reference number 114B in FIG. 2B. Furthermore, the repetition constructs can include an entity as an argument. For example, in rules 116A, x can be constrained, which yields the ability to repeat a set of statements a previously unknown number of times.

As shown in FIG. 2C, rules 116A can include any number of rules that relate to variables 122A. Rules 116A can also be organized in a hierarchical structure of rule sets that can contain rules and rule sets. The rules might then be parsed and translated to appropriate constraints, such as the first name rule can be translated to a “memberOf” constraint with a list of values extracted from the repository. Rules 116A are used to derive constraints 124 (shown in FIG. 1), and constraints 124 and variables 122A are then used to formulate CSP 120 (shown in FIG. 1). The output of CSP 120 solved by a CSP solver 130 (shown in FIG. 1) or any other solver, such as SAT or SMT.

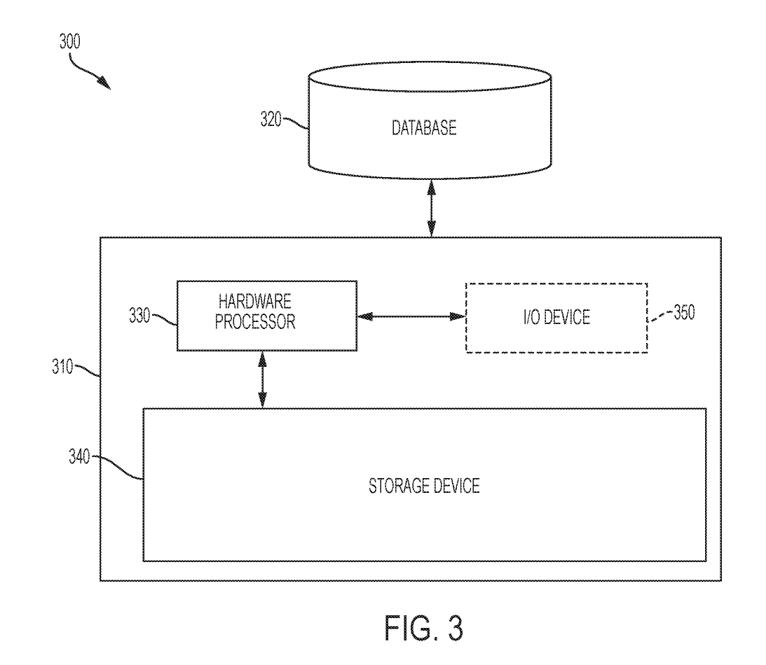

FIG. 3 depicts a system 300 capable of implementing one or more embodiments of the present disclosure. System 300 may include a computing device 310 and a database 320. Computing device 310 may include a hardware processor 330, a storage device 340 and an optional input/output (I/O) device 350. Database 320 may include one or more databases, hardware processor 330 may include one or more hardware processors and storage device 340 may include one or more storage devices. Database 320 may include the data sources and/or the targets or a portion of them. Alternatively or in addition, storage device 340 may include the data sources and/or targets or a portion of them. The fabricated test data may be stored in Database 320 and/or storage device 340. Hardware processor 330 may be configured to execute system/method 100 of FIG. 1 and, to this end, may be in communication with database 320 and receive data therefrom. I/O device 350 may be configured to allow a user (e.g., user 102 shown in FIG. 1) to interact with system 300. The dedicated software may be stored on storage device 340 and executed by hardware processor 330.

Database 320 may be stored on any one or more storage devices such as a flash disk, a random access memory (RAM), a memory chip, an optical storage device such as a CD, a DVD, or a laser disk, a magnetic storage device such as a tape, a hard disk, storage area network (SAN), a network attached storage (NAS), or others, or a semiconductor storage device such as a flash device, memory stick, or the like. Database 320 may be a relational database, a hierarchical database, object-oriented database, document-oriented database, or any other database.

Hardware processor 330 may be a central processing unit (CPU), a microprocessor, an electronic circuit, an integrated circuit (IC) or the like. Alternatively, computing device 310 may be implemented as firmware written for or ported to a specific processor such as digital signal processor (DSP) or microcontrollers, or can be implemented as hardware or configurable hardware such as field programmable gate array (FPGA) or application specific integrated circuit (ASIC). Hardware processors 330 may be utilized to perform computations required by computing device 310 or any of it subcomponents.

In some embodiments, computing device 310 may include an I/O device 350 such as a terminal, a display, a keyboard, a mouse, a touch screen, an input device or the like to interact with system 300, to invoke system 300 and to receive results. It will however be appreciated that system 300 can operate without human operation and without I/O device 350.

Computing device 310 may include one or more storage devices 340 for storing executable components, and which may also contain data during execution of one or more components. Storage device 340 may be persistent or volatile. For example, storage device 340 may be a flash disk, a random access memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as flash device, memory stick, or the like. In some exemplary embodiments, storage device 340 may retain program code operative to cause any of processors 330 to perform acts associated with any of the operation shown in FIG.1 above, for example analyzing data for extracting rules, generating data in accordance with rules, or others.

In some exemplary embodiments of the disclosed subject matter, storage device 340 may include or be loaded with the user interface. The user interface may be utilized to receive input or provide output to and from system 300, for example receiving specific user commands or parameters related to system 300, providing output, or the like.

Thus, it can be seen from the forgoing detailed description and accompanying illustrations that technical benefits of the present disclosure include systems and methodologies that provide rule guided fabrication of structured data and messages that allows fabrication of test data according to rules. The rules describe requirements that the fabricated data is required to satisfy, mainly in order to simulate real data. These rules may be defined by a testing engineer (i.e., a user) and/or may be automatically obtained from the involved environments. The disclosed data fabrication further allows fabrication of test data based on a combination of various rule types (such as analytics, constraints, transformation etc.), which are based on business logic and testing logic on top of data logic. The disclosed data fabrication may be a CSP based data fabrication solution.

According to the present disclosure, rules are defined independently of the ultimate file format layout that will be chosen for the test data. Because rules are defined independently of the file format layout, the complexity of the rules is not limited by the file format layout. Also because the rules are defined independently of the file format layout, complex relationships may be established between defined variables, complex rules may be imposed on the defined variables, and complex constraints may be derived from the complex rules. Also because the rules are defined independently of file format layout, the file format layout may take a variety of forms, including for example databases, messages, flat files, data streams, web service calls, and the like. Flat files can include positional, hierarchical, TSV, CSV, XML, XSD, JSON and other formats.

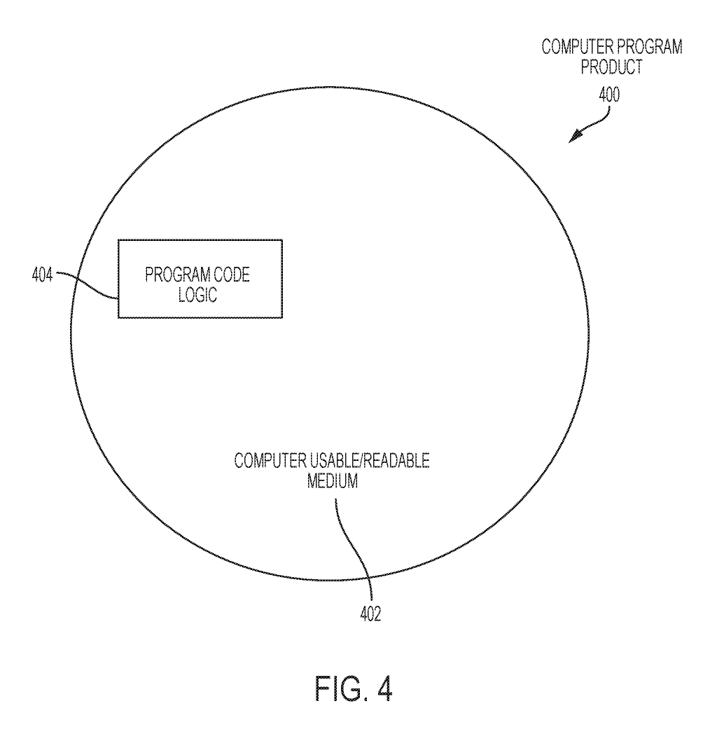

Referring now to FIG. 4, a computer program product 400 in accordance with an embodiment that includes a computer readable storage medium 402 and program instructions 404 is generally shown.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A computer implemented method for developing a system to fabricate test data into a database, the method comprising:
receiving, using a processor system, a file format layout of the database, wherein the database includes variables;
defining rules independently of the file format layout of the database;
receiving, using the processor system, the rules that are defined independently of the file format layout of the database;
wherein the rules impose constraints on the variables;
wherein the rules being defined independently of the file format layout prevents the rules from imposing any limit on a first manner in which the rules are defined;
wherein the rules being defined independently of the file format layout prevents the rules from imposing any limit on a second manner in which relationships between and among the variables are defined;
defining a constraint problem based on the variables and the constraints; and
solving the constraint problem.

2. The computer implemented method of claim 1, wherein solving the constraint problem generates an assignment of fabricated test data to each one of the variables.

3. The computer implemented method of claim 2 further comprising generating an output comprising the file format layout having the fabricated test data, wherein the fabricated test data conforms to the rules.

4. The computer implemented method of claim 3, wherein the file format layout comprises a template.

5. The computer implemented method of claim 1, wherein the constraint problem is solved using a constraint satisfaction problem (CSP) solver.

6. The computer implemented method of claim 1, wherein the rules include an individual rule that imposes a constraint on more than one of the variables.

7. The computer implemented method of claim 1, wherein the file format layout comprises is selected from the group consisting of:
a database;
a flat file;
a message;
a data stream; and
a web service call.

8-20. (canceled)
